(19) United States
(12) Patent Application Publication
(10) Pub. No.: US 2013/0321110 A1
(43) Pub. Date: Dec. 5, 2013

(54) Single-Pole Electromagnetic Transit

(71) Applicant: Darryl Clines, Saint Louis, MO (US)

(72) Inventor: Darryl Clines, Saint Louis, MO (US)

(21) Appl. No.: 13/488,266

(22) Filed: Jun. 4, 2012

(51) Int. Cl. H01F 7/02

(52) U.S. Cl. CPC H01F 7/0247
USPC 335/220

(57) ABSTRACT

A methodological system contained within a single-poled electromagnetic repulsive circuit allowing objects to be transported securely within the boundaries created by the single-poled electro-magnetic environment. This invention introduces a 3 (three) phase rhetorical theory and the indoctrination of the term “single bi-polar electromagnetic repulsion,” of which regulates competitive interaction among objects placed in motion and creates motion within the framework of principled engineered objects.

### BACKGROUND OF THE INVENTION

1. Field of the Invention

The present invention relates to a methodological system capable of creating motion within objects; controlling travel interactions among objects by the establishment of field boundaries, while applying the designed premise (“single bi-polar electromagnetic repulsion”). “Single Bi-Polar Electromagnetic Repulsion” is defined by two (2) principles; the creation of motion within objects by the engineering of electromagnetic mechanics; and the electromagnetic containment of interactive flow by the establishment of electromagnetic boundaries Objects are placed in motion and contained while in motion, by the engineering and the manipulation of this applied premise of “single bi-polar electromagnetic repulsion.”

2. Brief Description of the Prior Art

Currently, objects in transport are fueled and directed in a number of facets. For Example: Planes, trains and automobiles are fueled by natural resources and are man-made energy. Though these vehicle options travel capabilities cover a large variety of spaces, the security of the traveling objects are subjected to the handling of the user. In continuance of the concern of travel security, objects currently put in motion simultaneously have been compromised by human error and are governed by their harmonious agreement. These ailments of the current state of transportation are confronted with the introduction of a single-poled electromagnetic system methodology; rivaling the cost of natural resource replenishment and the human error sequence corrupting the harmonious goal of multi-object simultaneous transport.

The phase introduction of the manipulation and control of a single-poled electromagnetic environment will progress current transport objects securely (without the direct interaction between opposing objects) and allow competing traveling objects to be transported in a progressive levitated state while also traveling continuously by the sole influence of the adaptations of the single-poled environment.

### BRIEF SUMMARY OF THE INVENTION

The indoctrination of the “single bi-polar electromagnetic repulsion” methodology being with the exploration of single-pole electromagnetic fields and how poles existing in the same frequency can be applied to each other to create and control space; and create multi-principled, inclusive of directional motion and levitated motion. Phase 1 of this methodology explores single-pole frequency repulsion zones, used to retract direct interaction between one (1) point unto another. Phase 2 of this methodology explores the potential of creating motion by positioning two (2) independent single-poles in opposition as antagonist and agonist to create directional mobility. Phase 3 of this methodology explores the expanded potential, in the continuous progression of antagonist and agonist electromagnetic single-poles, of the Phase 1 peripheral repulsive boundary being position below the objects in motion, creating levitated motion. The continuous applied principles of this methodology will progress the initial boundary driven ideology of Phase 1 as it is used to direct the interaction of objects in motion, to the manipulation of the discovered principle(s) to create directional motion (Phase 2) and the creation of levitated directional motion (Phase 3).

### BRIEF DESCRIPTION OF THE SEVERAL VIEWS OF THE DRAWING

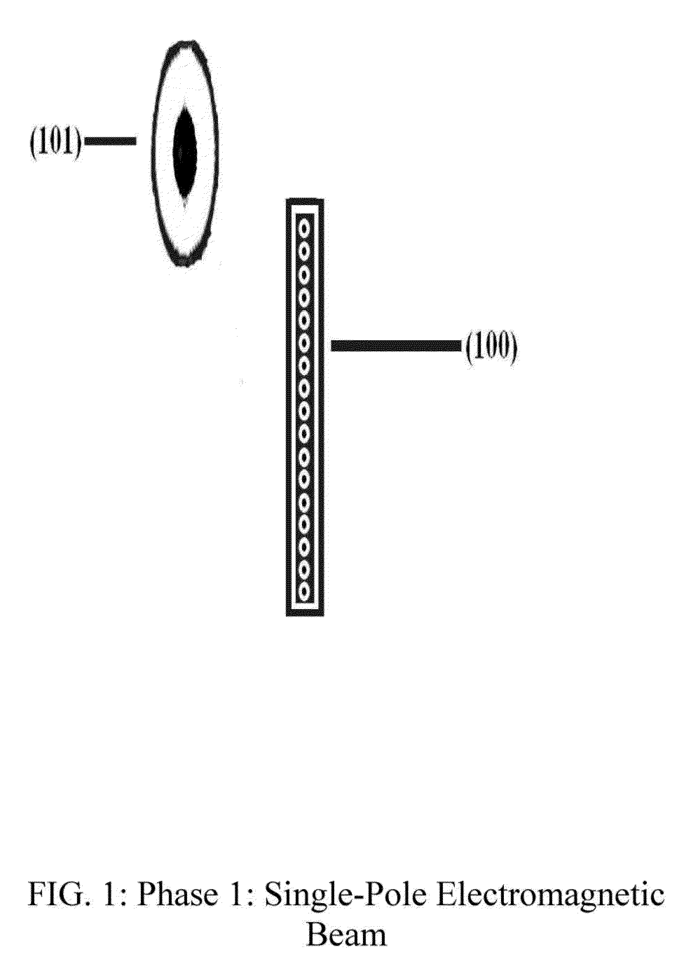

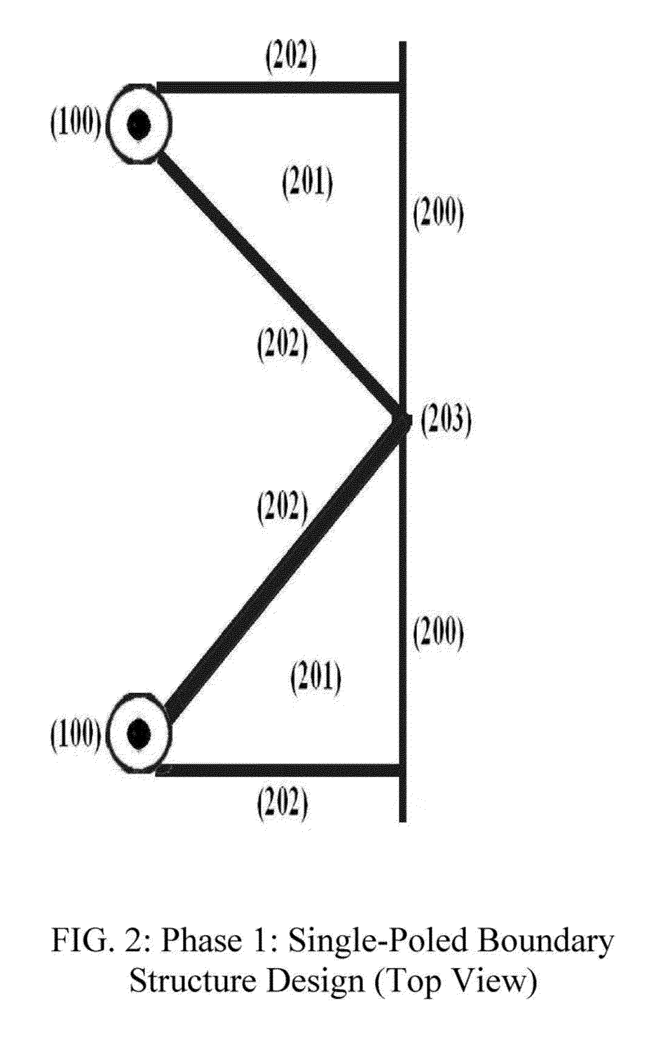

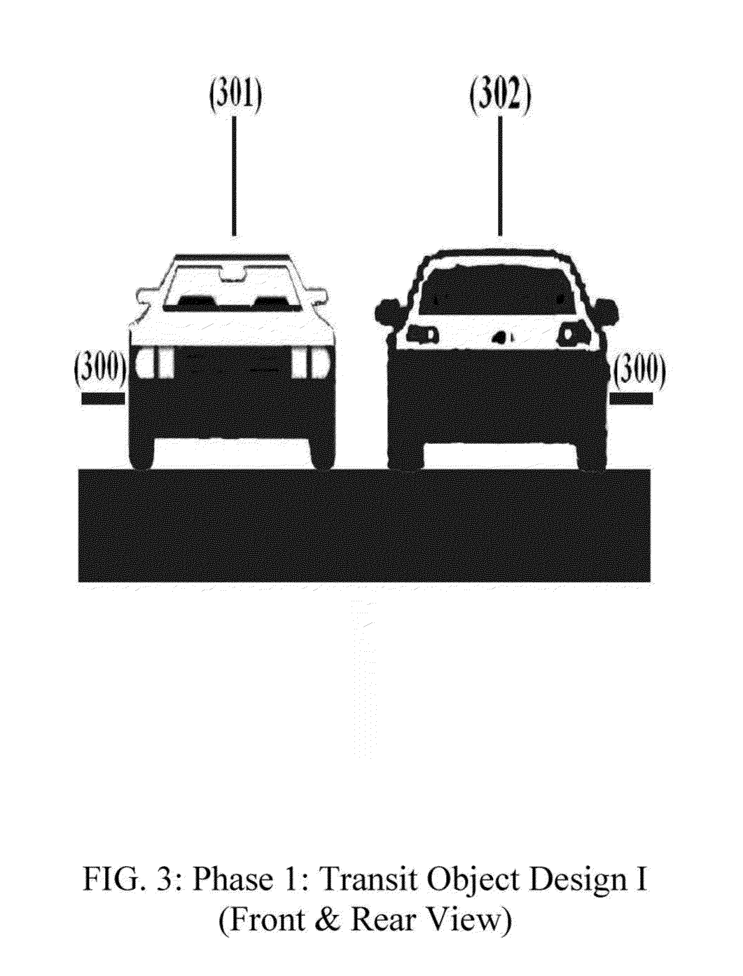

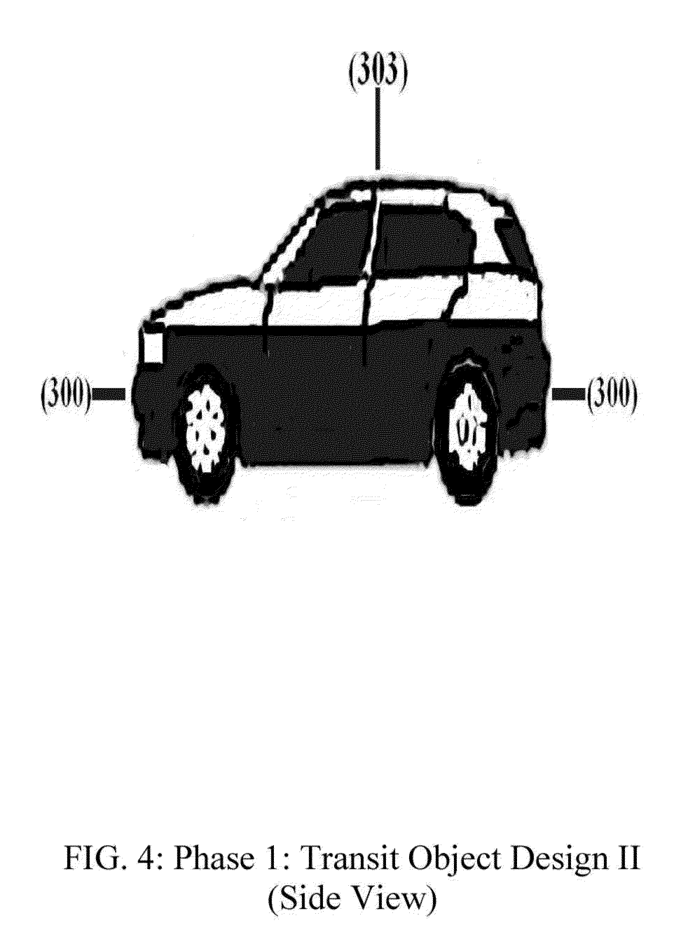

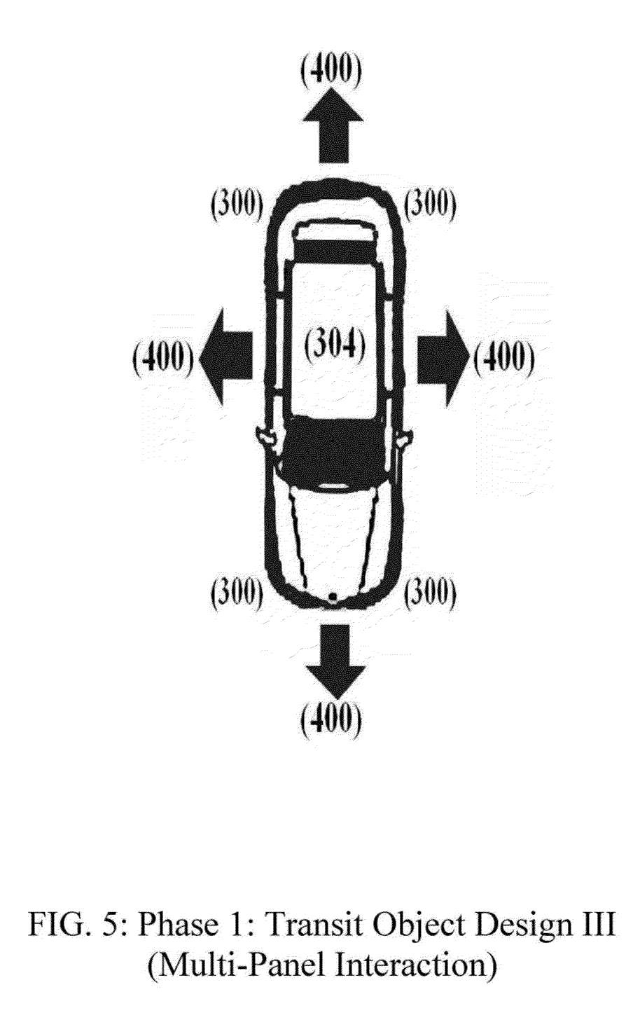

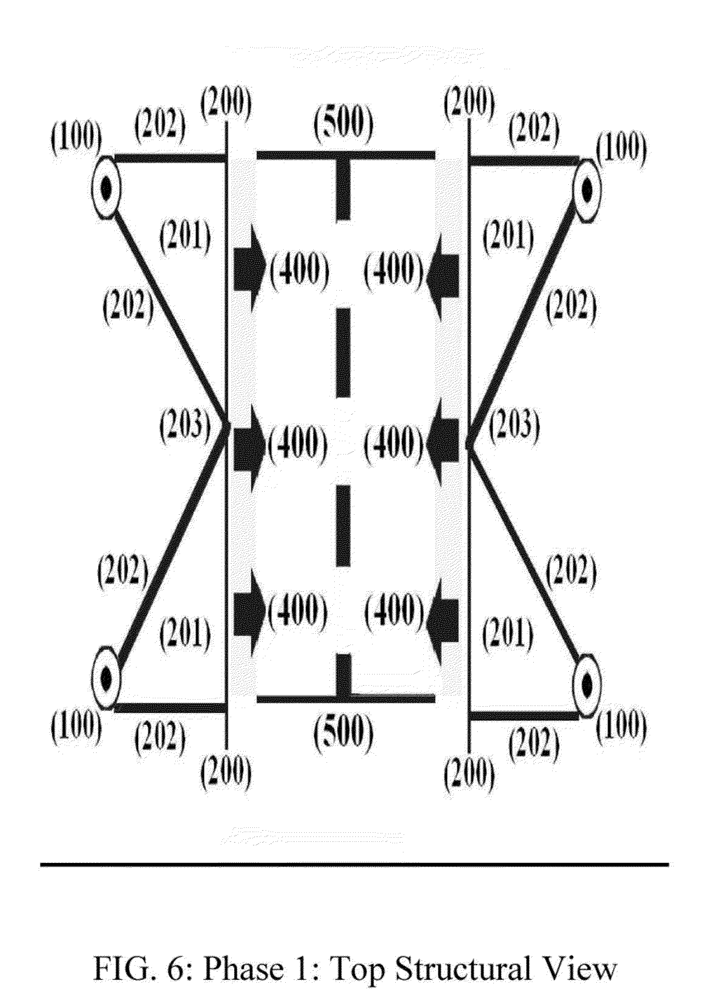

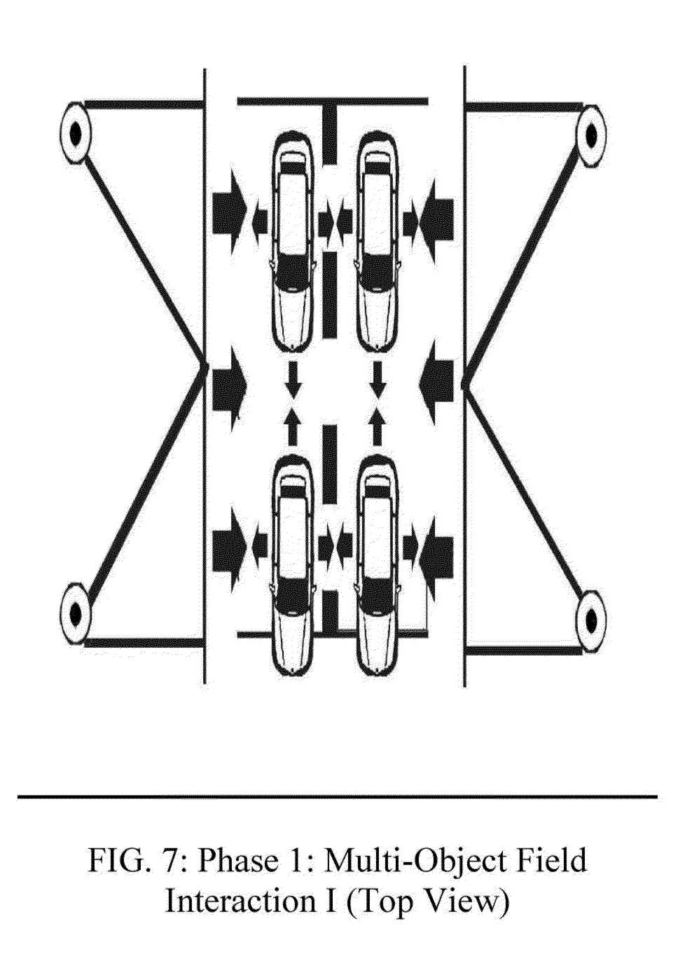

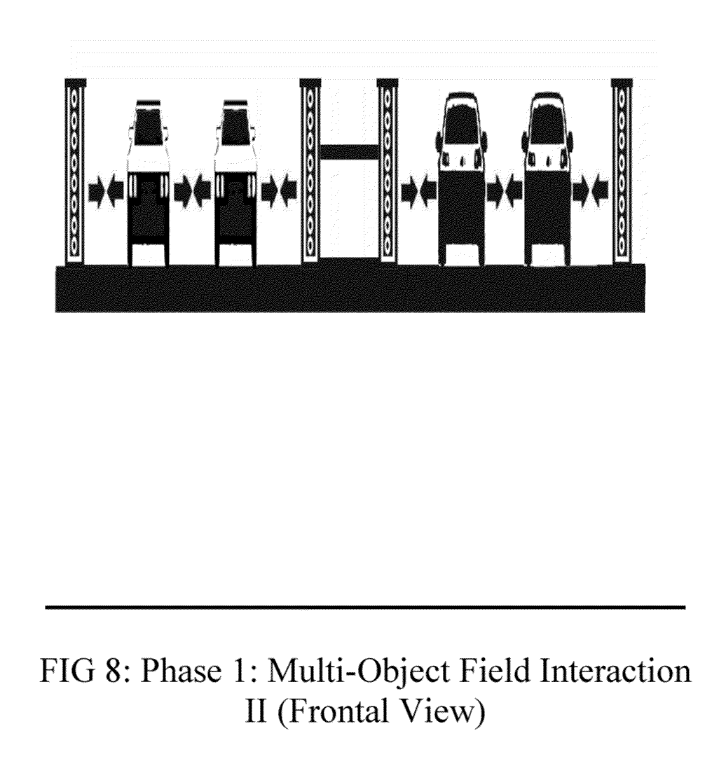

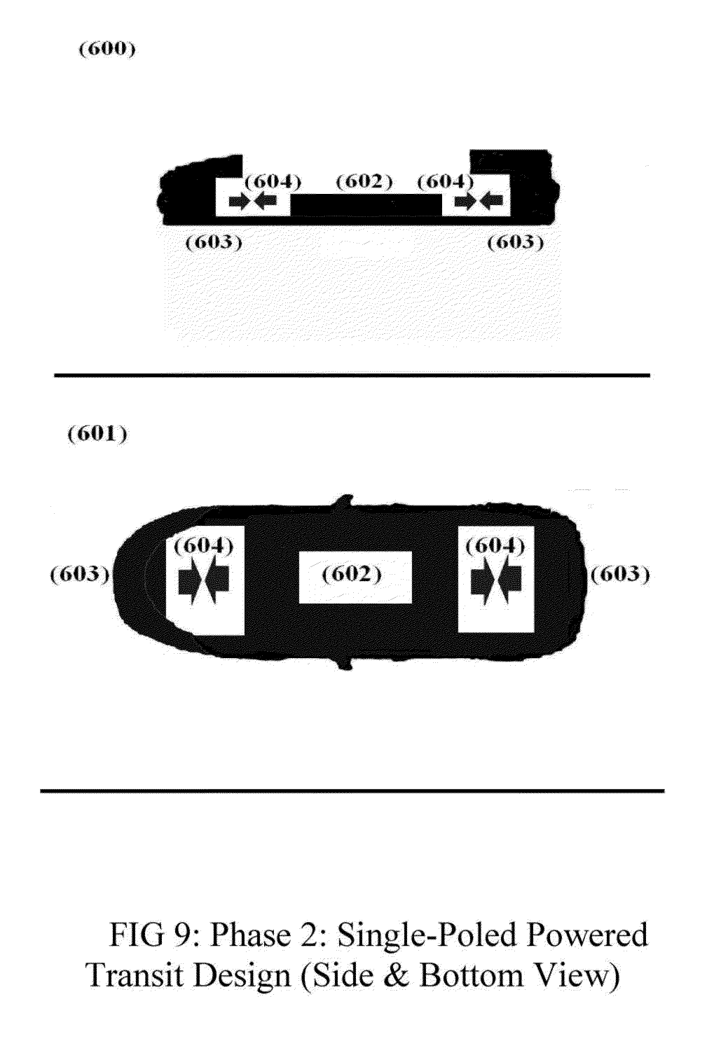

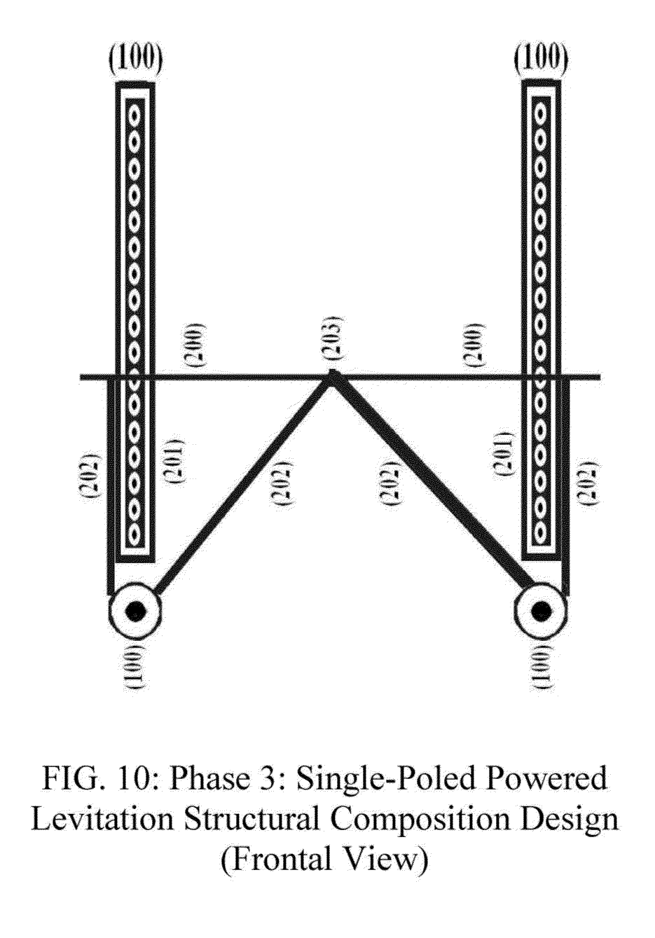

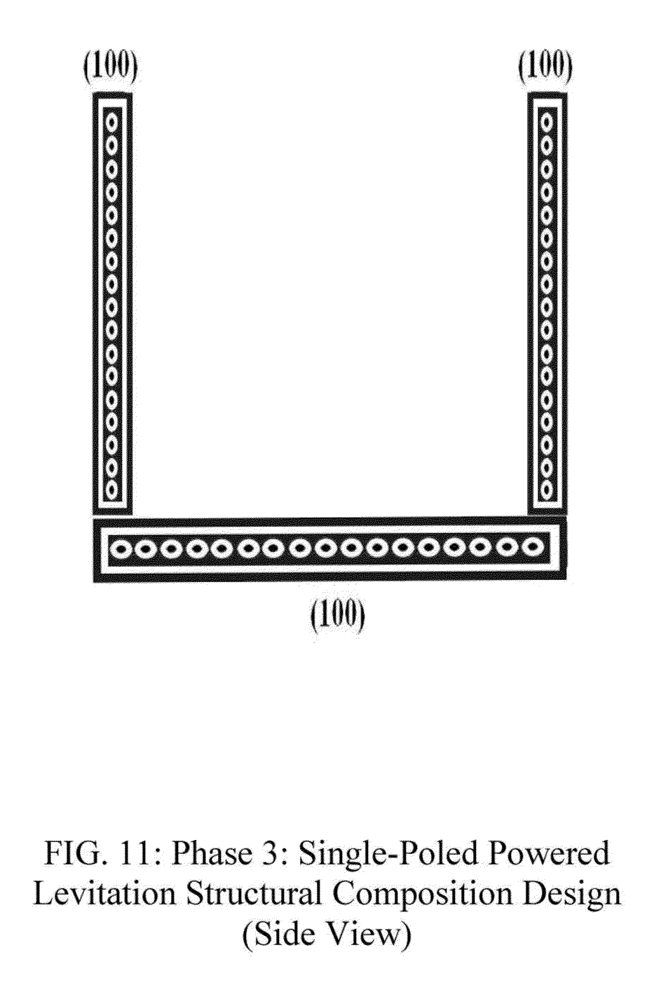

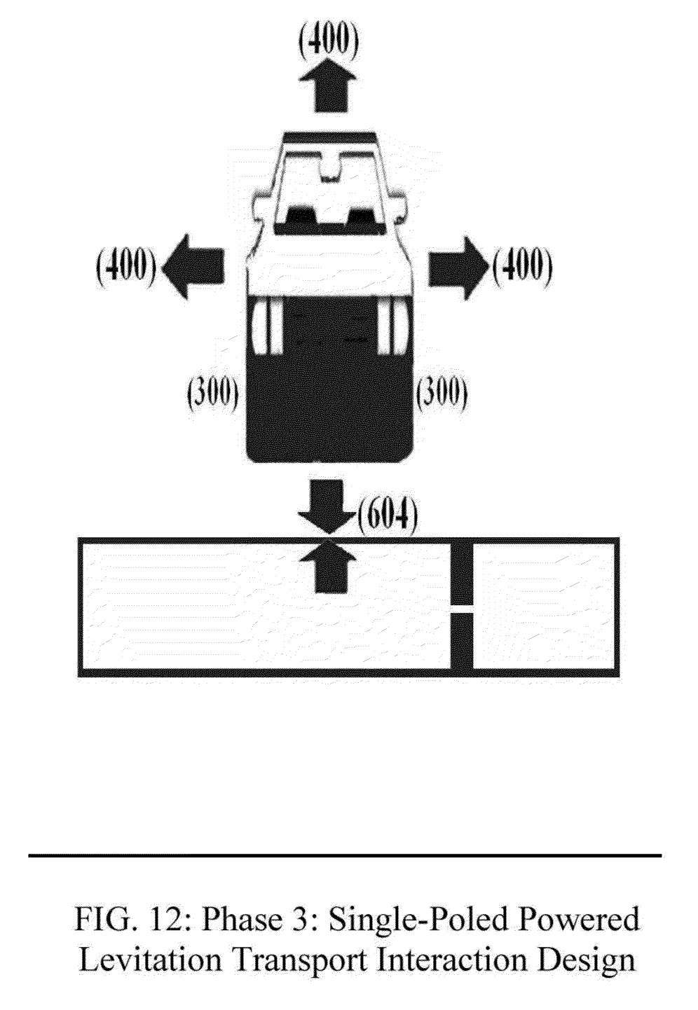

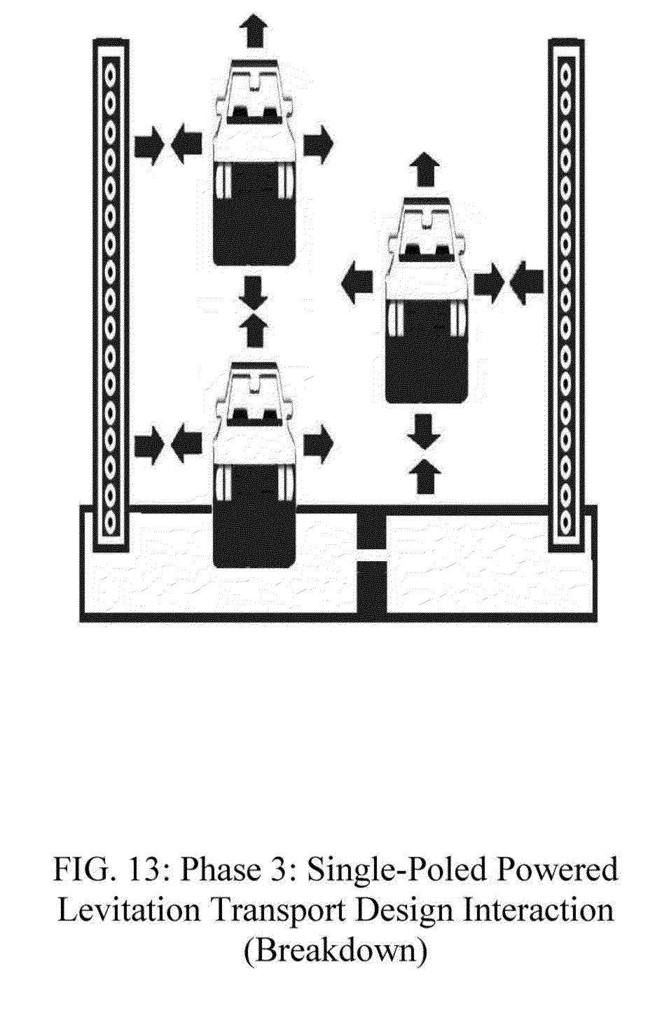

Please refer to the drawings at the end of this example for a key to the reference numbers

| Drawings | Name of Step |
|---|---|
| FIG. 1 | Phase 1: Single-Pole Electromagnetic Beam |
| FIG. 2 | Phase 1: Single-Poled Boundary Structure Design (Top View) |
| FIG. 3 | Phase 1: Transit Object Design I (Front & Rear View) |
| FIG. 4 | Phase 1: Transit Object Design II (Side View) |
| FIG. 5 | Phase 1: Transit Object Design III (Multi-Panel Interaction) |
| FIG. 6 | Phase 1: Top Structural View |
| FIG. 7 | Phase 1: Multi-Object Field Interaction I (Top View) |
| FIG. 8 | Phase 1: Multi-Object Field Interaction II (Frontal View) |
| FIG. 9 | Phase 2: Single-Poled Powered Transit Design |
| | (Side & Bottom View) |
| FIG. 10 | Phase 3: Single-Poled Powered Levitation Structural |
| | Composition Design (Frontal View) |
| FIG. 11 | Phase 3: Single-Poled Powered Levitation Structural |
| | Composition Design (Side View) |
| FIG. 12 | Phase 3: Single-Poled Powered Levitation Transport |
| | Interaction Design |
| FIG. 13 | Phase 3: Single-Poled Powered Levitation Transport |
| | Design Interaction (Breakdown) |

### OVERVIEW

Phase 1 and the introduction of a single-poled electromagnetically controlled transport system will be sought to begin in a commercial space. A commercial space introduction, as it may appear prudent to birth implementation because of the opportunity that it will allow to improve and fine-tune its continuous expansion, will confront the current ailments previously listed. For Example: The cost of parcel service delivery within the United States is currently confronted with a number of challenges inclusive of human error and timing; natural resource fuel replenishment; and the safe handling of items in transit, just to name a few. With the United States parcel delivery service industry's adaptation to a singled-poled electromagnetic methodology, parcel deliver can be enhanced by the creation of system allowing secure simultaneous transit of objects, while thriving on efficiency and loss prevention upon arrival. Attached are diagrams illustrating 1) maps citing the progressive development of a single-poled system expanding across the United States 2) the components of the single-poled environmental interaction and 3) a screen shot illustrating how these components interact.

In the accompanying drawings, in which several of various possible embodiments of the invention are illustrated, corresponding reference characters refer to corresponding parts throughout the several views of the drawings in which:

FIG. 1 (Phase 1: Single-Pole Electromagnetic Beam Structure) is a sketch of the . introduction of a prototype of a single-pole electromagnetic beam structure, engineered to create a single-pole electromagnetic repulsion boundary conduit.

FIG. 2 (Phase 1: Single-Poled Boundary Structure Design (Top View)) is a sketch of the top view of the single-pole electromagnetic boundary created by the synchronizing of the single-pole electromagnetic beam modules to form a single-pole electromagnetic boundary.

FIG. 3 (Phase 1: Transit Object Design I (Front & Rear)) is a sketch that illustrates a multi-view (Front & Rear) of a standard domestic vehicle custom designed in a single-pole electromagnetic repulsive casing.

FIG. 4 (Phase 1: Transit Object Design II (Side View)) is a sketch that illustrates a side view of a standard domestic vehicle custom designed in a single-pole electromagnetic repulsive casing.

FIG. 5 (Phase 1: Transit Object Design III (Multi-Panel Interaction) is a sketch that illustrates a top view of a standard domestic vehicle custom designed in a single-pole electromagnetic repulsive casing. This view also illustrates the directional static force emitted from the single-pole electromagnetic paneling.

FIG. 6 (Phase 1: Top Structural View) is a sketch that illustrates the development of the wall(s) encasing the electromagnetic environment, while also emitting an electromagnetically charge, setting a safe-travel boundary.

FIG. 7 (Phase 1: Multi-Object Field Interaction I (Top View)) is a sketch that illustrates the model for a single-pole electromagnetic safe travel field interaction among traveling single-poled objects from a overhead view.

FIG. 8 (Phase 1: Multi-Object Field Interaction II (Frontal View)) is a sketch that illustrates the model for a single-pole electromagnetic safe travel field interaction among traveling single-poled objects from a frontal view.

FIG. 9 (Phase 2: Single-Poled Powered Transit Design (Side & Bottom View)) is a sketch that illustrates an innovation in transportation that is accomplished without the assistance of fluid based energy sources; with multi-angular views.

FIG. 10 (Phase 3: Single-Poled Powered Levitation Structural Composition Design (Frontal View) is a sketch that illustrates the expansion of the peripheral single-pole electromagnetic repulsive boundaries, creating levitated travel condition.

FIG. 11 (Phase 3: Single-Poled Powered Levitation Structural Composition Design (Side View)) is a sketch that illustrates the side view of the structure design to create levitated travel conditions.

FIG. 12 (Phase 3: Single-Poled Powered Levitation Transport Interaction Design) is a sketch that illustrates an innovation in the design of traveling objects engineered to safe travel within the expanded boundaries of a single-poled powered levitation structural composition travel space. The electromagnetically charged outfits of Single-Poled Powered Levitation Transport designed vehicles' outer semblance are encased in a single-poled repulsive surface.

FIG. 13 (Phase 3: Single-Poled Powered Levitation Transport Design Interaction (Breakdown)) is a sketch that illustrates the enhanced travel possibilities created by the levitated travel innovation.

### DETAILED DESCRIPTION OF THE INVENTION

The preferred relationship among elements, including preferred logic and chronological order, is respectively illustrated sequentially beginning with FIG. 1 (Phase 1: Single-Pole Electromagnetic Beam) and ending with FIG. 13 (Phase 3: Single-Poled Powered Levitation Transport Design Interaction (Breakdown)). FIG. 1 (Phase 1: Single-Pole Electromagnetic Beam) and FIG. 2 (Phase 1: Single-Poled Boundary Structure Design (Top View)) introduces the single-pole electromagnetic repulsive beam structure (100) and the single-pole electromagnetic repulsive force emitting module(s) (101) contained within the structure (100) technologies: FIG. 2 (Phase 1: Single-Poled Boundary Structure Design (Top View)) further describes the components involved in the creation of the single-pole electromagnetic repulsive boundary (200). FIG. 2 (Phase 1: Single-Poled Boundary Structure Design (Top View) illustrates how 2 (two) single-pole electromagnetic beam structures (100), strategically placed, respectively emit synchronized multiple multi-directional single-pole electromagnetic repulsive charges in a triangular vector (202), forming 2 (two) single-pole electromagnetic repulsive fields (201) resulting in the creation of a single repelling boundary (200). The common frequency point (203) has to be tightly set to prevent the creation of a void in the continuous repelling boundary (200). It is also important to note that the suggested frequency length, emitted from each single-pole electromagnetic ,repulsive force emitting module (101) must be angularly set to adhere to the rules of the continuous boundary (200). The illustration represents the expanding construction of a single-poled electromagnetic system designed to host the electromagnetic transportation of object; a fundamental element of the initial operational integrity of the prospect of transporting object within it. FIG. 3 (Phase 1: Transit Object Design I (Front & Rear Views) introduces the engineering of a standard vehicle (301,302) with single-pole electromagnetic repulsive paneling (300). FIG. 3 (Phase 1: Transit Object Design I (Front & Rear Views)) displays a multi-directional view of a standard vehicle traveling south (301) and traveling north (302). Both directions highlight the single-pole electromagnetic repulsive paneling (300), depicted in BLACK. The single-pole electromagnetic paneling (300) is design to repel interaction between the traveling vehicle and other like vehicle, and the single-pole electromagnetic repulsive boundary (200). FIG. 4 (Phase 1: Transit Object Design II (Side View)) illustrates the side view of a standard vehicle traveling west's (303) single-pole electromagnetic repulsive paneling (300). FIG. 5 (Phase 1: Transit Object Design III (Multi-Panel Interaction)) displays the continuous surrounding single-pole electromagnetic repulsive paneling (300) encasing the standard vehicle (304). FIG. 5 (Phase 1: Transit Object Design III (Multi-Panel Interaction)) also displays the single-pole electromagnetic repulsive force (400) emitted directionally from the paneling surface (300). The opposing east and west directional force arrows (400) illustrate the repelling force emitted from the sides of the traveling vehicle, repelling the direct interaction among side traveling opposing like vehicles and the peripheral boundaries (200). The opposing north and south directional force arrows (400) illustrate the repelling force emitted from the front and rear ends of the traveling vehicle, repelling the direct interaction among front and back traveling opposing like vehicles. FIG. 6 (Phase 1: Top Structural View) illustrates the top view of the implementation model for a single-pole electromagnetic repulsive safe travel field. The completion of this model is the result of the construction of 2 (two) single-poled boundary structures (FIG. 2 (Phase 1: Single-Poled Boundary Structure Design (Top View))) placed on opposing sides of the street (500). The 2 (two) opposing single-poled boundaries (FIG. 2 (Phase 1: Single-Poled Boundary Structure Design (Top View))) form a coherence of repulsive boundaries (200) emitting static repelling single-pole electromagnetic repulsive frequency (400). The illustration represents an overhead view of single-poled electromagnetic system and further illustrates the directional single-poled electromagnetic charged emitted, forming an irrigational boundary for objects in motion. FIG. 7 (Phase 1: Multi-Object Field Interaction I (Top View) displays the interaction among single-pole electromagnetic repulsive engineered (300) standard vehicles (304) competitively traveling within the safe travel field of the single-poled boundary completed structure (FIG. 6 Phase 1: Top Structural View). Single-pole electromagnetic repulsive engineered (300) standard vehicles (304) traveling within the safe travel field (FIG. 6 Phase 1: Top Structural View) are structurally influenced to travel linearly among peripheral boundaries (200). The illustration represents the suggested engineered design of objects placed in motion within the single-poled electromagnetic system from an aerial view. FIG. 8 (Phase 1: Multi-Object Field Interaction II (Frontal View) illustrates the frontal view of travel conditions of vehicles (301, 302) within the safe travel field of the single-poled boundary completed structure (FIG. 6 Phase 1: Top Structural View). The illustration represents the suggested engineered design of objects placed in motion within the single-poled electromagnetic system from a frontal view. FIG. 7 and FIG. 8 (Multi-Object Field Interaction I & II) collectively represent the desired interaction amongst objects placed in simultaneous directionally governed motion. FIG. 9 (Phase 2: Single-Poled Powered Transit Design (Side & Bottom View)) introduces an innovation in transportation that is accomplished without the assistance of fluid based energy sources. The images above are of the bottom of a vehicle's frame (601) and of the side view of the frame of a vehicle (600). How “Fluid-Less” engineering is created is by a modular conductor (602) emitting single-poled electromagnetic force (604) against an opposing single-poled absorbing base (603), creating mobility (604). Intensification of the modular conductor (602), in either direction (604); will accelerate movement and/or decelerate movement (604). The theory behind this innovation is to create accelerated movement by applying a greater force to a single-poled static base (603), in scalable degrees, defined by an increase in controlled intensity. The pressurized system (604) scaled in degrees will determine the distance and time ratio (miles per hour) output of the traveling vehicle. This engineering can be applied all traveling vehicles. Illustrations 600 and 601 represent the engineering of objects in an attempt to create motion within those objects by the application of the principles of the “single bi-polar electromagnetic repulsion” methodology FIG. 10 (Phase 3: Single-Poled Powered Levitation Structural Composite Design (Frontal View)) introduces the expansion of the single-pole electromagnetic repulsive boundary (200) to the surface of the safe travel field of the single-poled boundary completed structure (FIG. 6 Phase 1: Top Structural View) creating levitated travel. FIG. 10 (Single-Poled Powered Levitated Transport Design (Frontal View)) represents the expansion of the single-poled electromagnetic system, placing the once peripheral created boundaries below the objects in motion, levitating objects in continuous motion. FIG. 11 (Phase 3: Single-Poled Powered Levitation Structural Composition Design (Side View)) displays the side view of the expanded safe travel field of the single-poled boundary completed structure (FIG. 6 Phase 1: Top Structural View) re-engineered (FIG. 10 Phase 3: Single-Poled Powered Levitation Structural Composite Design (Frontal View)) to allow levitated travel conditions. The single-poled boundary structures (100) will be placed as peripheral boundaries (200) and placed below 2 (two) single-poled boundary structures (200) positioned on the same side of the street. FIG. 11 (Single-Poled Powered Levitated Transport Design (Side View)) represents the expansion of the single-poled electromagnetic system, placing the once peripheral created boundaries below the objects in motion, levitating objects in continuous motion. FIG. 12 (Phase 3: Single-Poled Powered Levitation Transport Interaction Design) introduces the expansion of the single-pole electromagnetic repulsive paneling (300) of a standard vehicle, customized to travel in a levitated state. This illustration also has created 2 (two) single-pole electromagnetic repulsive panels (300) above and beneath the enhanced vehicle. The single-pole electromagnetic repulsive panel beneath the enhance vehicle allows for continuous levitated travel along the expanded single-pole electromagnetic repulsive boundary (200) below. The image represents the expansion of the single-poled electromagnetic system, placing the once peripheral created boundaries below the objects in motion, levitating objects in continuous motion. FIG. 13 (Phase 3: Single-Poled Powered Levitation Transport Design Interaction (Breakdown)) introduces the innovation in travel congestion. With the expansion of single-pole electromagnetic repulsive paneling (FIG. 12 Phase 3: Single-Poled Powered Levitation Transport Interaction Design), vehicles experiencing system outages and/or mechanical breakdowns will no longer interrupt the continuous flow of traffic. As illustrated in FIG. 13 (Phase 3: Single-Poled Powered Levitation Transport Design Interaction (Breakdown)) where 1 (one) of the 3 (three) vehicles experiences a power outage, the depleted vehicle will continue to emit multi-directional planes of retraction (300) engineered by the static properties of the single-pole electromagnetic repulsive paneling (300). This allows vehicles traveling around the depleted vehicle to continue their commute without directly interacting with the depleted vehicle. The bottom paneling (300) will not be engineered with the static properties of the single-pole electromagnetic repulsive system, but will be engineered with a pressurized frequency (604) allowing precision in landing and levitation transitions.

The progression of the principle indoctrination of “single bi-polar electromagnetic repulsion” represents the continuous application and the advancement, over time, of the manipulation of the duplicity of single-poles acting upon opposing single-poles as antagonist and/or agonist to set transit parameters and create multiple applications of motion and irrigational boundaries. It may be assessed that certain components contained within the progression of the overall application may be applied independently; challenging the necessity of suggesting that a progression should exist among all components. However, though each facet of the suggested progression may appear to be equally as independent of each other as they may also appear to be dependent of each other, the suggested progression exhibited was engineered to evolve the understanding of the methodology's conceptualization. It may further be assessed that certain components may be combined to ultimately eliminate what may be depicted, as well as suggested, as being necessary and/or unnecessary. To expose an obviousness which may be deduced as being structurally as well as progressively unnecessary is intended to expose a transparency of understanding which may be justified as a constant or even a necessity upon the methodological implementation.

The Single-Pole Electromagnetic Transit method does posses modifiable qualities as well as components that are may be applied without a progressive introduction. The most obvious, would be the principled byproduct of applied created motion. Objects may be placed in motion by the application of aspects of the outlined principle outside of the suggested electromagnetic singled-poled system field. Therefore, it should not be interpreted that electromagnetic single-poled directional motion (Phase 2) can only be created within the system's boundary presets.

In some cases, the practicality of introducing components in a strict successive application may appear to be an over-capitalized investment. If applied in variable subscription, the overall objective can still be accomplished. Henceforth, selective reasoning can be applied in determining the staging order of the implementation of the overall principled progression.

In subscription of the idea of staging order of the overall continuous progression of the said objective, it may all come to reason the independence of the retractable quality associated with negating disruptive and/or undesirable interactions among opposing objects. The challenge with this line of reasoning is vested in the interaction among elements not suited with the same single-poled electromagnetic frequency. For Example: If there are two (2) opposing objects in motion, retracting the shared single-poled emitted frequency, without the a field engineered to regulate the directional movement of both competing object, the interaction among uncontrolled outside elements within the in motion objects' path may interfere and/or disrupt the harmonious directional flow. Also, in respect to the in motion objects' interaction with uncontrolled outside elements, uncontrolled outside elements possessing an opposing polarized frequency (a positive verses a negative) will be attracted and/or drawn to the single-poled electromagnetically charged objects in motion. The introduction of Phase 1 engineered objects without the synchronized introduction of Phase 1 engineered repulsive field may create a list of possibilities that may be deduced as being unfavorable.

Motion, the attributed goal of the “single bi-polar electromagnetic repulsion” methodology” is performed currently in, by but not limited to, machines and computers. Planes, trains, automobiles, elevator systems and other motion generation transporting vehicles fulfill our current desires for space travel. For Example; Automobiles, trains and elevator systems drive cargo laterally and/or vertically, while planes drive cargo aerially.

Motion in our current society is fueled by either natural resource consumption and/or electricity. The cost of motion regulates the rate of frequency and/or the distance traveled by cargo aboard fuel governed apparatuses.

The byproducts created by the manipulation of the principles of “single bi-polar electromagnetic repulsion” could lead to a variety of possibilities which may be applied in a number of different areas. The Phase 2 (Single-Poled Powered Transit Design) could be applied to put in motion any object desired. The Phase 2 principle can be justified as “green” engineered transportation due to its lack of dependence on natural resource consumption.

The Phase 3 (Single-Poled Powered Levitation Transport Design) adaptation could be applied to levitate any object desired. For Example: Elevators, which currently possesses a number of electrical components to accomplish systematic elevation, could be simplified by Phase 3 implementation. A stationary base, positioned as a single-pole electromagnetic directional agonist, influenced by antagonistic single-pole electromagnetic directional force, with the desired interaction contained within a single-pole electromagnetic field could be utilized to simplify the elevation of desired objects at rest. An increase in force accomplished by the “single bi-polar electromagnetic repulsion” principle, in degrees, could be used to regulate levels of desired elevation. For Example: An elevator system contained within a 10 level building, called to the 5^{th} level, could be accomplished within respect to the principle by scaling the degrees of force applied to an agonistic single-pole electromagnetic base by an antagonistic single-pole electromagnetic base.

Systems focused on the transportations of objects in multi-directional destinations and/or platforms can benefit from the implementation of the principles introduced by the “single bi-polar electromagnetic repulsion” theory. System facilitators that utilize current methods that require consumption of resources that are costly as well as environmentally compromising could find the principle application cost efficient as well as environmentally conscious. Due to the simplicity of the principle application, maintenance of the functionality of the desired motion will be concise and succinct.

Products, devices and useful items produced by the “single bi-polar electromagnetic repulsion” methodology are the byproducts of “Green Energy” and the concept of “Safe Travel.” “Green Energy,” defined as energy that is produced by resources that have little to no environmentally compromising quality, is a byproduct of the “single bi-polar electromagnetic repulsion” principle. Energy, providing and/or stabilizing object motion, produced by this principle is accomplished by similar principles characterized in “green technology.” To further the distinction of the “single bi-polar electromagnetic repulsion” principle as a “Green Energy” addition, external fueling demands are desired to be accomplished by the intertwining of “Wind Energy” components and other forms of environmentally safe energy generating systems.

Objects in motion, engineered by the principles of Phase 1 of the “single bi-polar electromagnetic repulsion” method, provides interaction regulation among simultaneously competitive objects in motion. The byproduct of the principles of Phase 1 applied to simultaneously competitive objects in motion is loss prevention, as it relates to the prevention of interactive damage among objects. Safe Travel is the goal as well as a byproduct of the adoption of this Phase 1 principle.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

Though “electromagnets” are suggested as being a primary source of energy in the creation of this methodology, it should also be made clear that electromagnetic activity is the byproduct of a magnet's amplification being enhanced by electricity. What should be concluded is that if a magnet's amplification is enhanced by sources other than electricity, the same results may be accomplished.

Amplification of the properties of magnets can also be conducted by forcing 2 (two) single-poled opposing magnets closer together to increase the repulsion of the magnification. This consideration is important in defining that the goals of activity and multi-object interaction may also be created by what prior arts have discovered in the exploration of magnetic activity.

### Auxiliary Support Infrastructure

With the subscription of electromagnetically charged or enhanced vehicular commutes, the maintenance of a continuous power source will become integral. With the exploration of wind technologies, in response to the void presented by the continuous need for a rechargeable power source, the current infrastructure of natural resource replenishment stations (gas stations) can be re-engineered as circuit recharging stations. This adaptation will further campaign the call for green technology implementation and will eliminate the cost associated with oil drilling, it eventual distribution and its resource depletion. With respect to all innovations in alternative energy discovery, the process described within this application is adaptive as well as yielding.

What is claimed:

1. Single-Pole Electromagnetic Transit introduces the methodological premise entitled “Single Bi-Polar Electromagnetic Repulsion.” “Single Bi-Polar Electromagnetic Repulsion” encompasses two (2) principles as it relates to the creation of motion within objects by the engineering of electromagnetic mechanics; and the electromagnetic containment of interactive flow by the establishment of electromagnetic boundaries. The first principle, the creation of motion, is defined by two (2) opposite poles creating motion within a single-poled controlled environment, contained within a common body by one (1) antagonistic pole influencing the direction (motion) of the total body by pressing upon the base of the opposing agonistic pole. The second principle, the containment of interactive flow, is defined by the creation of single-poled electromagnetic boundary as a result of the repulsive response of multiple sequentially aligned single-poled electromagnetic beams, forming an electromagnetic boundary wall, repelling object interaction as a conduit of single-poled activity. Objects are placed in motion and contained while in motion, by the engineering and the manipulation of this applied premise of “single bi-polar electromagnetic repulsion.”

2. With the exploration of “single bi-polar electromagnetic repulsion” motion can be produced within traveling objects and be contained within a field, directionally emitting the same polarized electromagnetic force; while also improving safety; and reducing natural resource consumption and functional wear and tear. Objects in simultaneous competitive motion, and outfitted in single poled electromagnetic repulsive custom framing, to be placed in motion among objects, directionally competitive, without directly engaging the surrounding outfitted principled boundaries and the similarly suited objects. “Single Bi-polar Electromagnetic Repulsion” can be maintained within a field encased with the same but permanent, single poled electromagnetic boundary; preventing the direct interaction of same poled traveling objects with the outside peripheral boundary; creating a safe travel zone. Created motion within objects can be produced by creating a “single bi-polar electromagnetic repulsion” field within parked objects; creating directional motion within objects practical and independent of external fuel (fluid) replenishment.

3. The polarized as well as peripheral boundary can be applied to the traveling surface below the traveling objects to allow objects to travel in a continuous levitated state. Objects desired to be placed in a continuous levitated state must have single poled electromagnetic repulsive custom framing expanded to the bottom segment of the traveling object. A method and system to integrate magnetic levitation technologies within a networked guided transit system is provided. The magnetic levitation is used to replace wheels as a primary means of vehicle movement transmitter while also improving safety and reducing natural resource consumption and functional wear and tear.
